(19) United States
(12) Patent Application Publication
(10) Pub. No.: US 2013/0346983 A1
(43) Pub. Date: Dec. 26, 2013

(54) COMPUTER SYSTEM, CONTROL SYSTEM, CONTROL METHOD AND CONTROL PROGRAM

(71) Applicants: Masaki Kan, Tokyo (JP); Dai Kobayashi, Tokyo (JP)

(72) Inventors: Masaki Kan, Tokyo (JP); Dai Kobayashi, Tokyo (JP)

(73) Assignee: NEC CORPORATION, Minato-ku, Tokyo (JP)

(21) Appl. No.: 14/003,846

(22) PCT Filed: Mar. 7, 2012
(86) PCT No.: PCT/JP2012/001563

§ 371 Date: Sep. 9, 2013

(51) Int. Cl. G06F 9/46

(52) U.S. Cl. CPC G06F 9/46
USPC 718/100

(57) ABSTRACT

A control system comprises a property estimating means for estimating a property of a task or data on a computer system to be controlled on the basis of property estimation source data, one or more control executing means for controlling to stop/operate system components of the computer system, changing a task arrangement, changing a data arrangement and changing a data structure according to issued control commands, a control strategy determining means for determining, as a control strategy to be executed, control processing contents of one or a combination of the four controls on the basis of an operation situation of the computer system in the future derived from the estimated property of the task or data, and a control command issuing means for issuing control commands to the control executing means according to the control processing contents determined by the control strategy determining means.

### TECHNICAL FIELD

The present invention relates to a computer system, a control system, a control method and a control program.

### BACKGROUND ART

In recent years, the amount of data to be handled by computer systems increases. Thus, a large-scale computer system uses a distributed storage system in which data is distributed and stored in a plurality of storage nodes. With the technique, an arrangement of data in calculators or a processing to be performed in any calculator is realized by software or special hardware and an operation is dynamically changed according to a system state to adjust the amount of used resources in the system, thereby enhancing performance for a system user (client calculator). For example, there is a technique in which the number of servers is changed according to an access load thereby to address the access load.

Another problem is an increase in power consumption caused by an increase in size of the system. PLT 1 describes therein a system in which a non-access probability is calculated based on access statistics information to distributed storage nodes and data is rearranged by use of the calculated non-access probability in a distributed storage system. With the system described in PLT 1, data is arranged such that an expected value of a non-access time is higher, thereby prolonging a power saving mode of an individual disk node.

PLT 2 describes therein a calculator system in which I/O (Input/Output) loads are appropriately distributed. The calculator system described in PLT 2 calculates an average of I/O access frequencies to each integrated device as an estimated value of the I/O access frequency.

NPL 1 describes therein a time-series analysis technique for capturing and expressing characteristics of data based on the time-series data such as temperatures or earthquakes.

### CITATION LIST

### Patent Literature

PLT1: JP 2009-157571 A
PLT2: JP 2008-59315 A

### Non-Patent Literature

NPL1: Genshiro KITAGAWA, “Introduction to Time Series Analysis”, Iwanami Shoten, Publishers, 2005, p. 125-141

### SUMMARY OF INVENTION

### Technical Problem

One of the most essential problems in controlling a computer system is that information for controlling jobs (applications) or data is lacking. For example, the approach of the aforementioned technique has a problem that a data access unknown to the computer system cannot be predicted. The approach of the aforementioned technique further has a problem that a variation in access loads having no predictive information to the computer system cannot be addressed.

The computer system originally provides some services relating to the real world. Thus, the computer system is typically addressed for a predictable variation in loads by human's monitoring, determining and controlling situations of the real world. A simple example is that a server capability is enhanced and applications are extended in a shopping site for the Christmas season. That is, a change in environment outside of the computer system may assume a change in use form of the system in the near future.

However, recent globalization or improvement in information transmission speed increases a difficulty in such manual addressing. For example, there can occur an event in which a phenomenon occurring on the other end of the globe increases a specific load in the computer system.

A problem in performance of the current computer system may be due to a bottleneck for data I/O (Input/Output) in many cases. Therefore, there may be assumed that many of the problems in performance can be eliminated and a change can be adapted if the problems along with data I/O can be avoided. For example, it is considered that data is previously distributed and stored such that data I/O caused by a load is distributed against an increase in loads.

However, even the addressing, which may be enough in quantative terms of data I/O, may be advantageous or disadvantageous in the data structure depending on an access pattern to the data, and thus the data structure can be preferably controlled. There is required that a CPU load can be properly standardized and an arrangement of tasks not causing a network bottleneck along with data I/O can be controlled. The system components can be preferably controlled (the power supply of a node is interrupted, for example) in order to keep operating the system at power according to necessary performance. In this way, there may be assumed that not only the data arrangement but also the data structure, the task arrangement or the system components can be autonomously controlled in order to flexibly adapt to a change in use form of the computer system.

That is, the problem in the computer system is due to the fact that the computer system cannot flexibly adapt to a change in use form or a change in external environment. This is because there are not provided a required and sufficient (required and sufficient for the computer system) functions of control for flexibly adapting the computer system to a use form depending on a change in external environment, such as for automatically changing operation states of the system (such as calculator's load, properties of operating applications, properties of held and managed data) according to a change in use form or a change in external environment.

It is therefore an object of the present invention to flexibly adapt a computer system to a change in use form of the system or a change in external environment. More specifically, it is an object to provide a computer system, a control system, a control method and a control program capable of controlling system components, an arrangement of tasks, an arrangement of data or a data structure of the computer system on the basis of properties of future accesses to data.

### Solution to Problem

A control system according to the present invention comprises a property estimating means for estimating a property of a task or data on the basis of property estimation source data relating to the task operating on a computer system to be controlled or the data held in the computer system, one or more control executing means for controlling to stop/operate system components of the computer system, changing a task arrangement, changing a data arrangement or changing a data structure according to issued control commands, a control strategy determining means for determining, as a control strategy to be executed, one or a combination of control processing contents from among controlling to stop/operate system components of the computer system, changing a task arrangement, changing a data arrangement and changing a data structure on the basis of an operation situation of the computer system in the future derived from the property of the task or data estimated by the property estimating means, and a control command issuing means for issuing control commands to the control executing means according to the control processing contents determined by the control strategy determining means.

A computer system according to the present invention comprises a property estimating means for estimating a property of a task or data on the basis of property estimation source data relating to the task operating on the computer system or the data held in the computer system, one or more control executing means for controlling to stop/operate system components of the computer system, changing a task arrangement, changing a data arrangement or changing a data structure according to issued control commands, a control strategy determining means for determining, as a control strategy to be executed, one or a combination of control processing contents from among controlling to stop/operate system components, changing a task arrangement, changing a data arrangement and changing a data structure on the basis of an operation situation of the computer system at a predetermined or designated time in the future derived from the property of the task or data estimated by the property estimating means, and a control command issuing means for issuing control commands to the control executing means according to the control processing contents determined by the control strategy determining means.

A control method according to the present invention comprises the steps of estimating a property of a task or data on the basis of property estimation source data relating to the task operating on a computer system to be controlled or the data held in the computer system, determining, as a control strategy to be executed, one or a combination of control processing contents from among controlling to stop/operate system components of the computer system, changing a task arrangement, changing a data arrangement and changing a data structure on the basis of an operation situation of the computer system at a predetermined or designated time in the future derived from the estimated property of the task or data, and issuing control commands to one or more control executing means for controlling to stop/operate system components of the computer system, changing a task arrangement, changing a data arrangement or changing a data structure according to the determined control processing contents.

A control program according to the present invention causes a computer to execute a processing of estimating a property of a task or data on the basis of property estimation source data relating to the task operating on a computer system to be controlled or the data held in the computer system, a processing of determining, as a control strategy to be executed, one or a combination of control processing contents from among controlling to stop/operate system components of the computer system, changing a task arrangement, changing a data arrangement and changing a data structure on the basis of an operation situation of the computer system at a predetermined or designated time in the future derived from the estimated property of the task or data, and a processing of issuing control commands to one or more control executing means for controlling to stop/operate system components of the computer system, changing a task arrangement, changing a data arrangement or changing a data structure according to the determined control processing contents.

### Advantageous Effects of Invention

According to the present invention, it is possible to flexibly adapt the computer system to a change in use form or a change in external environment.

### BRIEF DESCRIPTION OF DRAWINGS

FIG. 1 It depicts a block diagram illustrating an exemplary structure of a control system in a computer system according to an exemplary embodiment of the present invention.

FIG. 2 It depicts a block diagram illustrating an exemplary structure of a property estimation processing executing means.

FIG. 3 It depicts a block diagram illustrating another exemplary structure of the property estimation processing executing means.

FIG. 4 It depicts an explanatory diagram illustrating an exemplary data form held by a property record managing unit.

FIG. 5 It depicts an explanatory diagram illustrating another exemplary data form held by the property record managing unit.

FIG. 6 It depicts a block diagram illustrating an exemplary structure of a control strategy determining/command issuing means.

FIG. 7 It depicts a flowchart illustrating an exemplary processing flow of a property estimation processing.

FIG. 8 It depicts a flowchart illustrating an exemplary processing flow of a property model estimation processing.

FIG. 9 It depicts a flowchart illustrating an exemplary processing flow of a control strategy determination/execution processing.

FIG. 10 It depicts a block diagram illustrating an exemplary structure of a control system in a distributed storage system according to an example of the present invention.

FIG. 11 It depicts an explanatory diagram illustrating another exemplary property information stored in a property record management DB according to the example.

FIG. 12 It depicts a block diagram illustrating an outline of the control system according to the present invention.

FIG. 13 It depicts a block diagram illustrating another exemplary structure of the control system according to the present invention.

### DESCRIPTION OF EMBODIMENTS

An outline of an exemplary embodiment according to the present invention will be first described. The present invention is characterized by estimating a property of data or a task by use of any property estimation source data and tentatively estimating a property of target data or task by use of a property model of the data or task with a similar property when the property estimation source data is lacking. The present invention is characterized by determining whether control is possible by use of the model information or information from an external information source and issuing a control command to each component in the system.

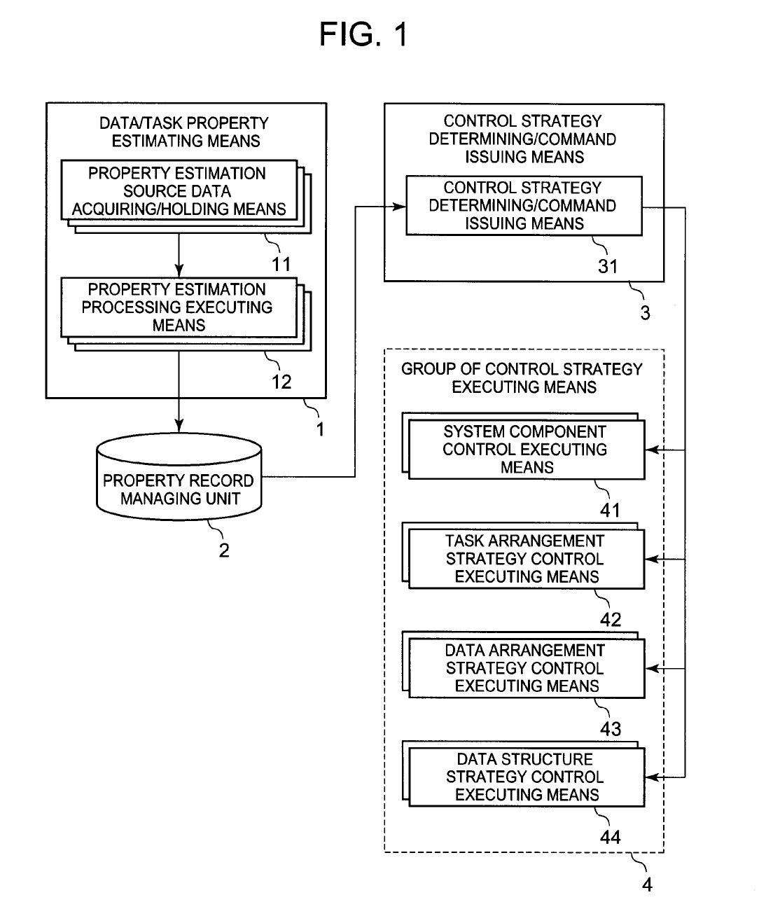

The exemplary embodiment of the present invention will be described below with reference to the drawings. FIG. 1 is a block diagram illustrating an exemplary structure of a control system in a computer system according to the exemplary embodiment of the present invention. The control system in the computer system illustrated in FIG. 1 comprises a data/task property estimating means 1, a property record managing unit 2, a control strategy determining/command issuing means 3, and four control strategy executing means (or a system component control executing means 41, a task arrangement strategy control executing means 42, a data arrangement strategy control executing means 43 and a data structure strategy control executing means 44) as a group of control strategy executing means 4.

The data/task property estimating means 1 estimates a property of data held and managed by a computer system to be controlled or a task processed on the computer system. In the example illustrated in FIG. 1, the data/task property estimating means 1 includes a property estimation source data acquiring/holding means 11 and a property estimation processing executing means 12. These may be mounted as software operating on the computer. The data/task property estimating means 1 may include a plurality of property estimation source data acquiring/holding means 11 and a plurality of property estimation processing executing means 12, respectively.

A task indicates a unit by which an application or a service processing realized on the computer system to be controlled is executed. A data property or a task property indicates a trend of use or operation of the current or future data or task (such as when to be executed or when to be accessed) or a trend of access to the data (such as excessive Read, excessive Write, sequential access, random access). A method, a calculation equation and a calculation program for expressing the data or task property is called property model.

The property estimation source data acquiring/holding means 11 acquires and holds (stores) data for estimating a property (property estimation source data). The property estimation source data acquiring/holding means 11 is realized by software for acquiring history logs of data or task, and software and a recording medium for recording the history logs, for example. The property estimation source data may be data indicating part of a property of a task or data such as information indicating an actual use situation, and a special requirement therefor is not provided. The property estimation source data may be at least data relating to data or task to be estimated.

The property estimation processing executing means 12 estimates a property model indicating a property of data or task by use of data (such as history logs) stored in the property estimation source data acquiring/holding means 11, and stores the estimation result in the property record managing unit 2. One or more property models are held on the system. A property model to be estimated may be previously prepared or may be generated by a model generating means 123 described later during execution of the estimation processing.

The property estimation processing executing means 12 uses property estimation source data acquired from the property estimation source data acquiring/holding means 11 to select an optimum model for a property of future data or task, or a combination of such property models from among one or more property models, for example. A selection reference employs a probability of a property model, or a degree (likelihood) in which the property model is suitable as a model indicating a property of current or future data or task to be estimated. “Likelihood” includes a likelihood (function) that a numerical value indicating the value is expressed in a function.

The property record managing unit 2 holds and manages property information as information on a property model estimated by the property estimation processing executing means 12. The property record managing unit 2 is realized by database software, a calculator and a recording medium for operating the same, for example.

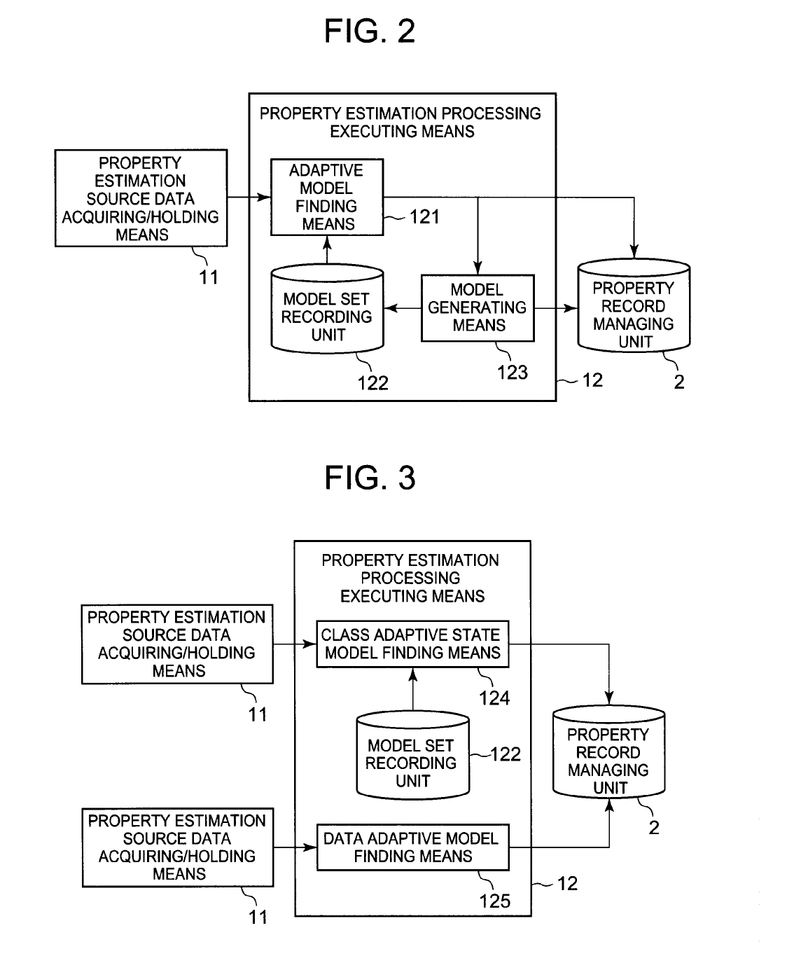

FIG. 2 is a block diagram illustrating a more-detailed exemplary structure of the property estimation processing executing means 12. As illustrated in FIG. 2, the property estimation processing executing means 12 may include an adaptive model finding means 121, a model set recording unit 122, and a model generating means 123.

The adaptive model finding means 121 selects an optimum property model or a combination of optimum property models for target data or task as adaptive models from among a group of property models stored in the model set recording unit 122. For example, the adaptive model finding means 121 receives data from the property estimation source data acquiring/holding means 11 to calculate a likelihood, and selects a property model indicating a most excellent likelihood having a threshold or more as an adaptive model. The thus-selected adaptive model is stored as a property model estimation result in the property record managing unit 2.

The model set recording unit 122 holds and manages information on property models to be subjected to likelihood calculation or candidate property models for a property model of data or task in the system to be controlled. The model set recording unit 122 is realized by database software, a calculator and a recording medium for operating the same, for example.

When a model suitable for property estimation source data is not present in the existing property models, the model generating means 123 generates a new model and stores it in the model set recording unit 122. The present system may be configured without the model generating means 123.

FIG. 3 is a block diagram illustrating another exemplary structure of the proper estimation processing executing means 12. As illustrated in FIG. 3, the property estimation processing executing means 12 may include the model set recording unit 122, a class adaptive state model finding means 124, and a data adaptive model finding means 125.

The exemplary structure in FIG. 2 assumes that data or a task to be subjected to property estimation and a property model adapted thereto take 1:1. However, it may be possible that the data or task and the property model are not handled at 1:1 and sets of data or tasks are handled. For example, when an access time zone to the data is determined per user, it is assumed that a property model is preferably applied to per metadata (such as user as owner) given to the data.

Thus, there is required a mechanism for handling sets of data and allocating a property model per set. A set of data will be called “class” below according to the present invention. Exemplary classes include a similar set clustered by similarities between users, groups or contents (such as document describing a topic of ◯◯), and the like.

The class adaptive state model finding means 124 selects an appropriate property model or a combination of appropriate property models from a group of property models stored in the model set recording unit 122 similarly to the adaptive model finding means 121 illustrated in FIG. 2. For example, the class adaptive state model finding means 124 receives data from the property estimation source data acquiring/holding means 11, makes a likelihood calculation, and selects a property model indicating a most excellent likelihood having a threshold or more for an application model. The class adaptive state model finding means 124 stores the thus-selected property model as an estimation result in the property record managing unit 2. In the present example, a likelihood calculation of the adaptive property model is not made per data, but by use of the property estimation source data of the set of data belonging to the class to which the data for which a property is to be estimated belongs, an adaptive property model for the class is found (estimated) and stored in the property record managing unit 2.

The data adaptive model finding means 125 calculates a property model per data from the property model found by the class adaptive state model finding means 124. The data may belong to a plurality of classes. Therefore, the data adaptive model finding means 125 takes a sum of the adaptive property models, or estimates a property model per data by use of a method for selecting a model with a highest likelihood. The data adaptive model finding means 125 may analyze individual property estimation source data of target data, and may estimate a data-specific property model when the data is not suitable for any class adaptive model.

In this way, a concept of class is introduced so that the amount of calculations for property estimation can be reduced or future accesses to data with no data access history logs can be estimated. The above description has demonstrated the example in which a set of data is handled as class, but a set of tasks may be similarly handled as class for the tasks for processing the data by use of classification per metadata of the data. Additionally, other example of the classification of the set of tasks may include classification depending on a task generation source or a type of the function of the task.

The property record managing unit 2 holds and manages property information (property models according to the present exemplary embodiment) estimated by the property estimation processing executing means 12. The property record managing unit 2 is realized by database software, a calculator and a recording medium for operating the same, for example.

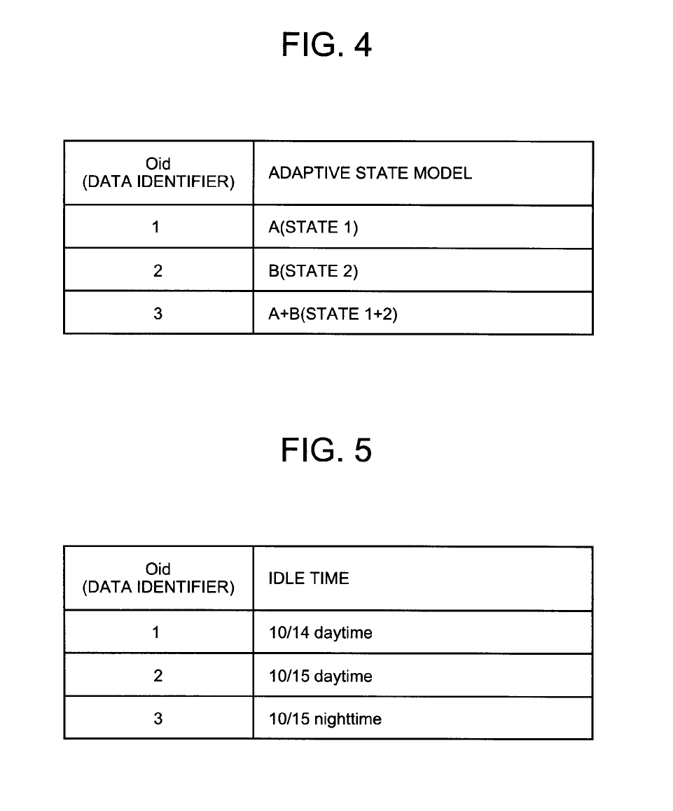

FIG. 4 is an explanatory diagram illustrating an exemplary data holding form of the property record managing unit 2. As illustrated in FIG. 4, the property record managing unit 2 may associate an identifier (“Oid”) for specifying data with a property model (“adaptive state model”) adapted thereto for storage. FIG. 4 illustrates an example in which information of adaptive state model=“property model A” is associated with Oid=1 data for storage.

The property models A and B are property models expressing states 1 and 2, respectively. For example, the property model A (state 1) may be a model such as linear equation indicating the property that the amount of accesses increases in proportion to time, and the property model B (state 2) may be a model such as trigonometric function indicating the property with more accesses in the daytime and less accesses in the nighttime. In this case, since the Oid=1 data is the property model A, the data is found to have an access pattern that the amount of accesses increases in proportion to time. Since the Oid=2 data is the property model B, the data is found to have an access pattern that the amount of accesses changes by the day. Since the Oid=3 data is the property models A+B, the data is found to have an access pattern that the amount of accesses increases in proportion to time while the amount of accesses increases by the day.

As illustrated in FIG. 5, the information on the property models is not stored as it is, and may be stored as information subjected to one-stage conversion (information on control instructions derivable by use of the property models). FIG. 5 is an explanatory diagram illustrating other exemplary data holding form of the property record managing unit 2. For example, a time zone (Idle time zone) in which data is not used in the future is estimated, the non-use time is stored with a specific node focused, and when the specific node is controlled to stop in the time zone, the information on the Idle time zone may be stored per data identifier. Thereby, calculations during the control are facilitated. FIG. 5 illustrates the example in which the Oid=1 data is associated with information of Idle time zone=“10/14 daytime” for storage, for example. The Idle time zone information is assumed to be derivable from the estimated property model (“property model A” in this example). Thus, the calculations for the derivation may be made until being stored in the property record managing unit 2.

The control strategy determining/command issuing means 3 determines a control strategy adapted to the conditions based on the property information on the data or task estimated by the data/task property estimating means 1, and issues control commands to a group of control strategy executing means for executing the determined control strategy. In the example illustrated in FIG. 1, the control strategy determining/command issuing means 3 includes a control strategy determining/command issuing means 31.

The control strategy determining/command issuing means 31 determines a control strategy by use of the property information stored in the property record managing unit 2, and issues, as needed, control commands based thereon to four control strategy executing means provided in the system including the system component control executing means 41, the task arrangement strategy control executing means 42, the data arrangement strategy control executing means 43, and the data structure strategy control executing means 44. The control strategy determining/command issuing means 31 is realized by respective software operating on the computer, for example.

The group of control strategy executing means 4 is realized by respective software operating on the computer, and hardware such as calculator controlled in associated therewith, for example. The physical operation executing places of the control strategy executing means 41 to 44 are different depending on an applied system. For example, the control strategy executing means 41 to 44 may not necessarily be configured to operate on the same calculator. A plurality of control strategy executing means 41 to 44 may be present, respectively, and in this case, may operate on different calculators.

The control strategy executing means 41 to 44 capable of actually controlling a system to be controlled may be employed, and any method for mounting the means is possible. A structure of the system to be controlled may be possible, and a structure of other different system (such as management system for managing the system to be controlled) from the system to be controlled may be possible. Other system herein has a function by which the system is controlled thereby to change a state or the like of the system to be controlled.

The system component control executing means 41 controls the operation states of the components configuring the system to be controlled (which will be called system components) in response to a control command from the control strategy determining/command issuing means 31. Specific examples include software for changing an operation mode defined in ACPI (Advanced Configuration and Power Interface) in a node calculator configuring the distributed computer system. The system components to be controlled may be in smaller units such as hard disk, not limited to a calculator. For example, to stop rotating a platter of the hard disk by driver software or to stop the power supply of the entire hard disk corresponds to controlling the system components. To change a rotation frequency of the CPU or to stop activating the GPU board corresponds to controlling the system components.

A control command by the control strategy based on the data or task property is issued to the system component control executing means 41, thereby expecting power saving or improvement in task performance.

The task arrangement strategy control executing means 42 controls the method (determination destination) for the means for determining which system component the task executed on the system is executed in response to the control command from the control strategy determining/command issuing means 31. As a specific example, the task arrangement strategy control executing means 42 controls a task allocating method for a task allocation functioning unit (software) in the distributed computer system. For example, the task arrangement strategy control executing means 42 sets an operation algorithm when a plurality of task allocation algorithms is mounted in software. By way of example, the task arrangement strategy control executing means 42 changes a setting for allocation by round-robin algorithm to a setting for changing an allocation rate depending on a measured load state of each node. Exemplary allocating methods may include a method for preferentially allocating a node storing therein data used by tasks.

Other exemplary task arrangement determination control may be to enable control such as to change an arranged node by an identifier given to a task, and the like. Exemplary arranged nodes may include a node mounting thereon hardware (such as GPGPU or GPGA) capable of rapidly executing specific processing, a node where software mounted for rapid processing is installed, and the like. An identifier given to a task may be given by any job executing middleware, for example.

The data arrangement strategy control executing means 43 determines a system component in the realized system where data is stored in response to the control command from the control strategy determining/command issuing means 31. A determination of a data storage destination desirably includes a function of moving arranged data or increasing duplicates.

The data arrangement strategy control executing means 43 is realized by software for arranging data in the distributed storage system, for example. For example, a plurality of arrangement algorithms is mounted and any one to be used is changed so that the data arrangement algorithm in the distributed storage system may be realized. The data arrangement strategy control executing means 43 receives a data moving command from the control strategy determining/command issuing means 31, and performs various control processing such as a data moving processing.

The data structure strategy control executing means 44 changes a method for determining a storing system or changes a system for storing existing data relative to the means for determining which structure is used for storing data in the computer system when the data can be stored in a plurality of structures, for example. A command of changing a data storing system is issued by the control strategy determining/command issuing means 31 also to the data structure strategy control executing means 44, and the data structure strategy control executing means 44 changes a data storing system in response to the command. As a simplest example, the data structure strategy control executing means 44 performs a processing of storing the data stored in the hard disk on a memory and changing a storage database (transferring data).

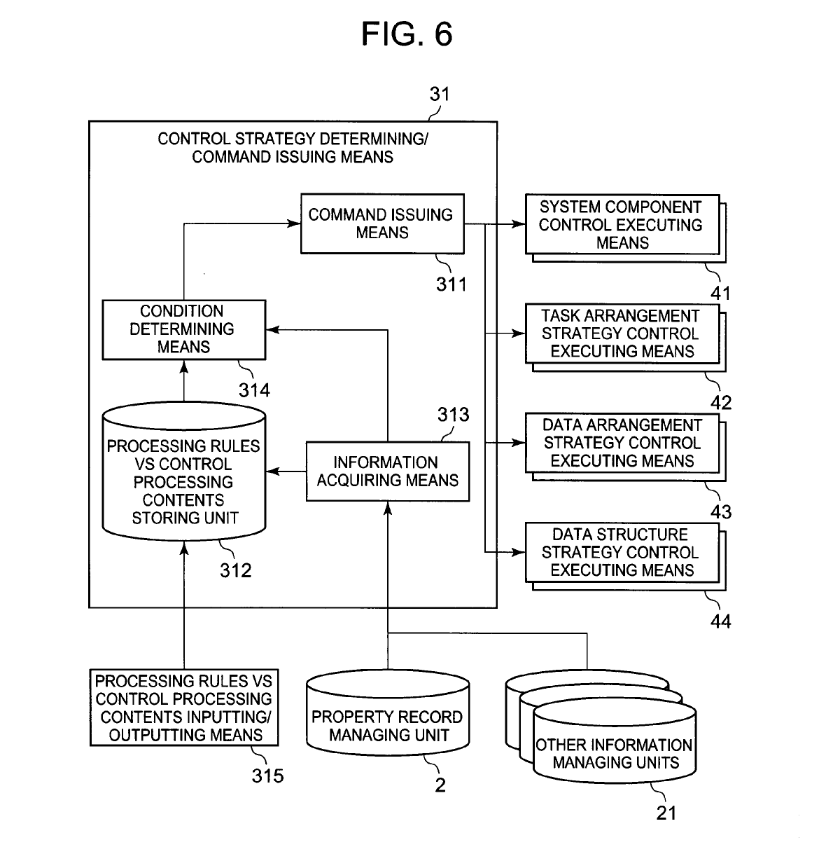

The control strategy determining/command issuing means 31 will be more specifically described below. FIG. 6 is a block diagram illustrating a more-detailed exemplary structure of the control strategy determining/command issuing means 31. As illustrated in FIG. 6, the control strategy determining/command issuing means 31 may include a command issuing means 311, a processing rules vs control processing contents storing unit 312, an information acquiring means 313, and a condition determining means 314.

In this example, the command issuing means 311 actually issues control commands to the four control strategy executing means provided in the system including the system component control executing means 41, the task arrangement strategy control executing means 42, the data arrangement strategy control executing means 43 and the data structure strategy control executing means 44. The command issuing means 311 typically transmits the commands to the respective strategy control executing means 41 to 44 operating in a different calculator from the calculator where the command issuing means 311 operates via a network interface. The issued control commands are passed from the condition determining means 314 to the command issuing means 311.

The processing rules vs control processing contents storing unit 312 is a storage device for associating conditions (rules) for any control with information on control command contents and storing them. A rules vs control processing contents inputting/outputting means 315 may be further provided as a means for editing the contents of the processing rules vs control processing contents storing unit 312.

The information acquiring means 313 acquires information required for condition determination by the condition determining means 314 from the property record managing unit 2 or other information managing unit 21. Information on which information is acquired from where may be previously defined by a setting file or the like. The information acquiring means 313 acquires information indicating a situation of the real world acquirable via other information managing unit 21, not limited to information indicating a situation of the computer system to be controlled. Other information managing unit 21 herein is any information holding means or information providing means other than the property record managing unit 2.

Exemplary information provided by other information managing unit 21 may include the following.

Weather forecast

Power information of data center where system is operating

Load information of calculator node configuring system

Log information of any service operating on calculator node configuring system

Information (such as Web page, service called micro blog) present on WWW (World Wide Web)

Service indicating TV broadcast contents, and TV broadcast's subtitles information

Such external information is used, thereby flexibly adapting the system to a change in the real world.

The condition determining means 314 uses the contents of the processing rules vs control processing contents storing unit 312 and the information acquired from the information acquiring means 313 to determine whether to execute the control processing contents stored in the processing rules vs control processing contents storing unit 312 as a control strategy on the basis of the property model of each task or each data stored in the property storage managing unit 2. Specifically, the condition determining means 314 determines whether the situation indicated by the information acquired from the information acquiring means 313 (not only the system situation but also the real world situation) meets a condition (rule) for any control stored in the processing rules vs control processing contents storing unit 312, thereby determining a control strategy to be executed. When determining that the condition is met, the condition determining means 314 requests the command issuing means 311 to issue a command of executing the control contents indicated by the control processing contents to the strategy control executing means 41 to 44.

The conditions (rules) and the control processing contents for specific control will be described below by way of example. There will be described herein, as a simplest example, a case in which a node with less recent amount of accesses is stopped for power saving. In this case, the rule is “when a node having a certain or less amount of accesses in the latest ◯ hours is present.” The control command set (control processing content) is “to stop a node having a certain or less amount of accesses.”

With a specific explanation of the operations, access log information per node is present for other information managing unit 21, and the information acquiring means 313 acquires the access log information. Then, the condition determining means 314 detects a node having a certain or less amount of accesses in the latest ◯ hours from the access log information, and if the node is present, instructs the command issuing means 311 to issue a control command set registered in association with the rule to the strategy control executing means capable of controlling the target node.

At this time, when node No. 1 has a certain or less amount of accesses, the command issuing means 311 issues a power supply stop command to the system component control executing means 41 (such as power supply control program) capable of controlling the node No. 1.

A determination as to whether a control condition is met is made not only by directly using the information acquired from the information acquiring means 313 but also by using the situation of the system to be controlled derived by applying a future time (time designated by a rule or a predetermined time) to a property model. For example, the condition determining means 314 may determine whether the system to be controlled meets the control condition at that time with function calculations by giving variables to the results obtained by previously giving time information indicating a future date/time (or elapsed time from a current point of time) to the data acquired by the information acquiring means 313 or the property model, and giving a conditional equation expressed by the variables as the control condition. In addition to the conditional equation, information on a date/time as determination reference, or information on identifier or range of data or task to be used may be given as the control conditions. Not the conditional equations but the determination processing program itself may be given to the system. For example, an address where the determination processing program is actually stored may be given as rule information thereby to cause the condition determining means 314 to execute the determination processing program.

The aforementioned example indicates that a control command is issued only to the system component control executing means 41 for simplification, but part of the data may be transited before stopping the node by use of the data/task property estimation result. For example, when the node No. 1 has a low access load but holds periodically-accessed data A, if the data A is not moved and the node is stopped, the node No. 1 has to be activated when an access to the data A is made, and thus a system processing capability is deteriorated due to the activation standby time. The control command set may be added with other processing such as “to stop a node having a certain or less amount of accesses and to move data to be accessed to another node before stopping node.”

In this case, in addition to the above operations, the processing of acquiring a property model of the data held by the node No. 1 from the property record managing unit 2, extracting a data identifier having a high data access probability (the data A) from the acquired property model, and instructing the data arrangement strategy control means 34 to move the data A to another node may be added before the node No. 1 is stopped.

The command issuing means 311 may instruct the task arrangement strategy control executing means 42 to use a node other than the node No. 1 as a data A-related task arrangement strategy as needed. When the data is not necessarily moved and it is seen that only READ as a property model of the data A is present or a method for accessing the data A is limited to READ, the command issuing means 311 may issue a command of changing a READ-target node of the data A to another node to the data arrangement strategy control means 34 and the task arrangement strategy control executing means 42.

In this way, in the control strategy determining/executing means 3, the control strategy determining/command issuing means 31 issues a combination of control command to one or more means among the system component control executing means 41, the task arrangement strategy control means 33, the data arrangement strategy control executing means 43 and the data structure strategy control executing means 44, thereby enabling system control such as power saving.

The processing rules vs control processing contents storing unit 312 can hold a plurality of aforementioned rules. Each rule may be associated with a corresponding control command set for storage. Other exemplary rule is system control in which when the name of a product dealt in the shopping site of the product is displayed on TV subtitles information, a resource of the shopping site is increased. In this case, the rule is “when the name of a specific product is detected by the external information recording unit as TV subtitles information” and the control command set is “to increase calculators for the shopping site (to increase calculator nodes, to change a data arrangement algorithm for distributing loads, to distribute and arrange data of the shopping site, to create replicas for distributing loads, to change the task arrangement algorithm for the shopping site for addressing the increase in calculators).”

Further, there may be controlled such that when power of the entire data center reaches a defined value, a node with a low priority is stopped. In this case, the rule may be “a value of the consumed power monitor for the entire data center reaches a certain value”, and the control command set may be “to reduce the number of operational calculators (to summarize task/data addressed by a low-load node to another node, or to change a data arrangement and a task arrangement for increasing stoppable node and to issue a node stop command).” By doing so, power saving can be achieved.

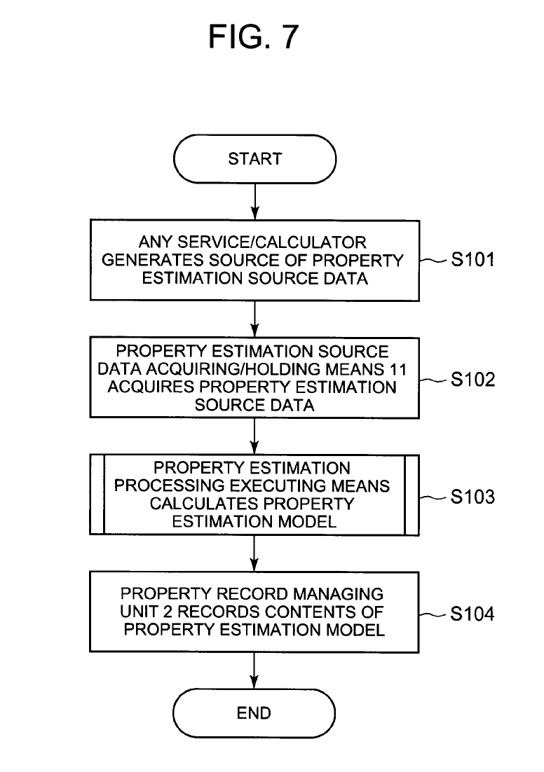

The operations of the present exemplary embodiment will be described below. The control operations according to the present exemplary embodiment are mainly divided into a property estimation processing part and a control strategy determining/executing part. The property estimation processing will be first described. FIG. 7 is a flowchart illustrating an exemplary processing flow of the property estimation processing according to the present exemplary embodiment. The property estimation processing is periodically performed, for example. The execution cycle may be arbitrary.

At first, an arbitrary service or calculator operating on the computer system to be controlled by the control system according to the present exemplary embodiment generates data used for making a property estimation (property estimation source data) while performing a predetermined function (step S101 in FIG. 7). Exemplary data to be generated may be access logs to a storage node, which are generated (updated) when a storage access is made in the distributed storage system. Step S101 is periodically performed irrespective of the property estimation processing in the control system. Thus, the property estimation processing is substantially started with step S102.

The property estimation source data acquiring/holding means 11 acquires the property estimation source data generated in step S101 at a predetermined timing (such as periodically or at an updated timing) (step S102). As an example, software for realizing the property estimation source data acquiring/holding means 11 performs a processing of reading the above storage access log data. The property estimation source data is limited to neither the storage access log data nor one kind.

Then, the property estimation processing executing means 12 uses the property estimation source data acquired in step S102 to estimate (calculate) a property model expressing a property of a task or data for the task operating on the computer system to be controlled or the data held in the system (step S103). Step S103 will be described below in details. When the property model is estimated, the property estimation processing executing means 12 associates the task or data as a property estimation target with property model information indicating the estimated property estimation model (property model), and records them in the property record managing unit 2 (step S104). The property estimation processing executing means 12 writes (updates) the contents of the estimated property model in the database for realizing the property record managing unit 2, for example.

Steps S102 to S104 are repeatedly performed for the property estimation processing.

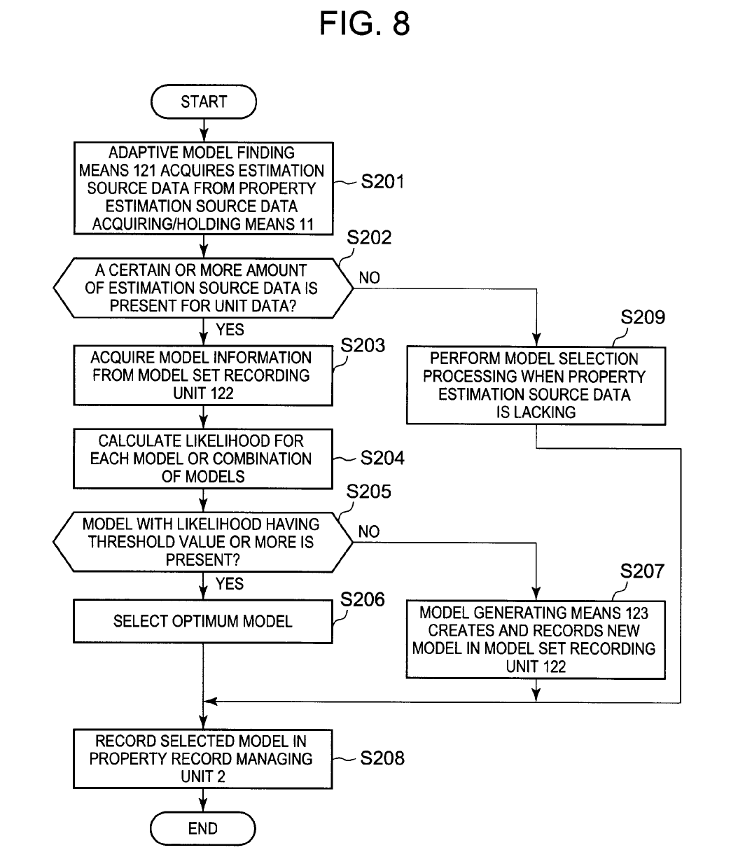

The property model estimation processing in step S103 will be described below in more details. FIG. 8 is a flowchart illustrating a more-detailed exemplary processing flow of the property model estimation processing (step S103 in FIG. 7).

In the property model estimation processing, the adaptive model finding means 121 in the property estimation processing executing means 12 first receives the property estimation source data from the property estimation source data acquiring/holding means 11 (step S201), and determines whether a certain or more amount of property estimation source data is present for the task or data to be estimated (step S202). Herein, when a certain or more amount of property estimation source data is present, the processing proceeds to step S203, and when no data is present, the processing proceeds to step S209.

When sufficient property estimation source data is present, the adaptive model finding means 121 acquires information on a candidate property model from the model set recording unit 122 (step S203). Then, the adaptive model finding means 121 uses the acquired property estimation source data to make a likelihood calculation per acquired model and per combination of models (step S204). Then, the adaptive model finding means 121 determines whether any of the calculated likelihoods is a previously-designated threshold or more (step S205). When one or more models having a likelihood of the threshold or more are present, the adaptive model finding means 121 selects a model with a best likelihood as a property model of the task or data to be currently estimated (step S206). When a model having a likelihood of the threshold or more is not present, the model generating means 123 creates a new model from the property estimation source data, and records it in the model set recording unit 122 (step S207).

In step S208, the information on the models selected or estimated in steps S206, S207 and S209 is associated with the information on the data or task to be estimated, and is recorded in the property record managing unit 2. When the model generating means 123 is absent, it is determined that the property is unknown in step S207, and the property record managing unit 2 may record the information indicating unknown property. For example, the property models for property unknown data and property unknown task may be prepared and recorded.

On the other hand, when the property estimation source data is lacking, a processing of tentatively applying any model is performed (step S209). The tentative model determination processing may include the following by way of example.

At first, a property unknown model is prepared and is tentatively applied. This may be the same as when the model generating means 123 is absent.

Additionally, there is a method for applying an adaptive model of other data or task from metadata given to data or task to be estimated. For example, an adaptive model of data or task to which the same metadata is given may be selected. For example, for data or a task only for data accesses, similarities of the contents between the data are compared, and the same adaptive model as the data having the similar contents may be applied.

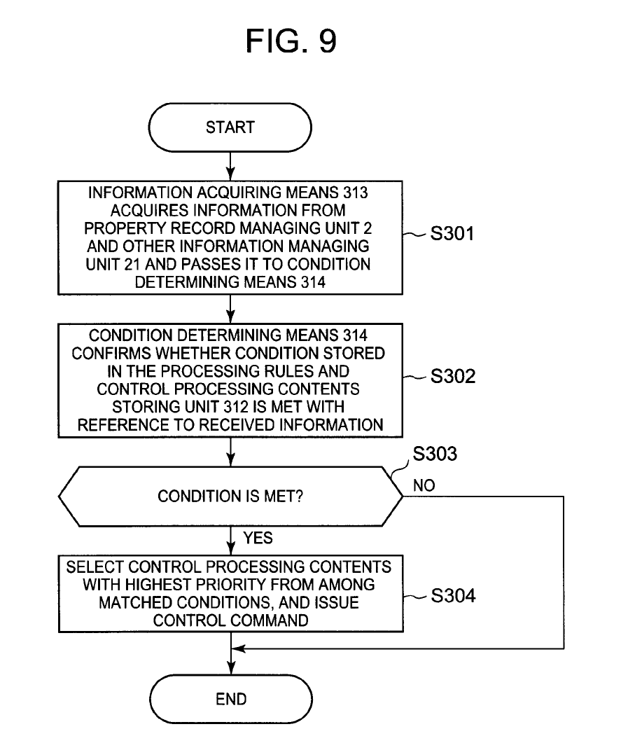

A processing flow of the control strategy determination/execution processing according to the present exemplary embodiment will be described below with reference to the flowchart of FIG. 9. FIG. 9 is a flowchart illustrating an exemplary processing flow of the control strategy determination/execution processing according to the present exemplary embodiment. In the example illustrated in FIG. 9, the information acquiring means 313 first acquires information from the property record managing unit 2 or other information managing unit 21, and passes it to the condition determining means 314 (step S301). The information acquiring means 313 acquires various items of information from the property record managing unit 2 or other information managing unit 21 according to a predetermined method, for example. The condition determining means 314 may request the information acquiring means 313 to acquire necessary information according to the conditions (processing rules) stored in the processing rules vs control processing contents storing unit 312. In this case, the condition determining means 314 may pass information for specifying the necessary information described in the rule to the information acquiring means 313, and the information acquiring means 313 may acquire information from the property record managing unit 2 or other information managing unit 21 based on the information.

Then, the condition determining means 314 determines whether the passed information or a situation of the computer system and others indicated by the information matches with any of the conditions stored in the processing rules vs control processing contents storing unit 312 (step S302). When the condition is met (Yes in step S303), the condition determining means 314 subsequently determines the control processing contents having a highest priority among the matched conditions as a control strategy to be executed, and requests the command issuing means 311 to issue a control command. The command issuing means 311 issues necessary control commands to the strategy control executing means 41 to 44 according to the control processing contents determined as the control strategy to be executed in response to the request from the condition determining means 314 (step S304).

On the other hand, when no condition is met (No in step S303), the processing is terminated without performing anything.

The processing flow is periodically repeated, thereby flexibly adapting to a change in use form of the computer system from the current time to the near future. This is because the system component control executing means 41, the task arrangement strategy control executing means 42, the data arrangement strategy control executing means 43, and the data structure control strategy executing means 44, which can actually perform necessary control in order to adapt to the changes, are provided, and a property model expressing a future property is estimated for each task operating on the system to be controlled or each data held in the system to be controlled so that if a processing rule and a control processing content are given, a control strategy to be executed can be derived without missing a chance based on property estimation source data or external environment data.

### EXAMPLES

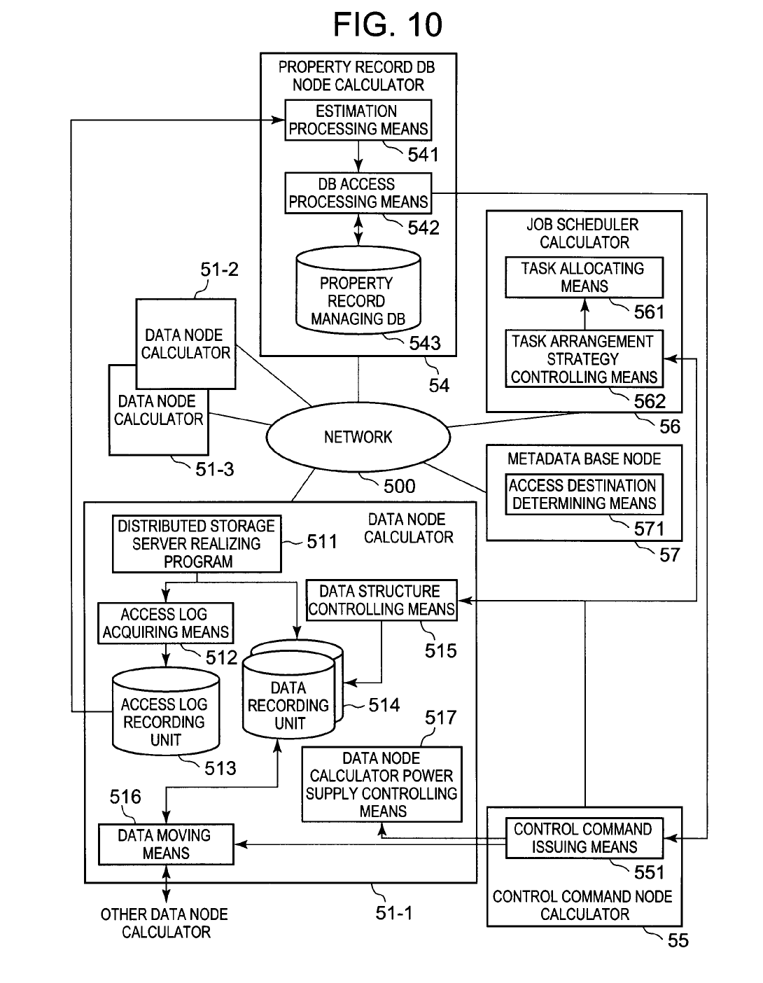

The exemplary embodiment according to the present invention will be described below by use of a specific example. The present example is such that the present invention is applied to a distributed calculation system for performing jobs on the distributed storage system and the data in the distributed storage system. FIG. 10 is a block diagram illustrating an exemplary structure of the present example. The control system in the distributed storage system illustrated in FIG. 10 comprises a network 500, data node calculators 51 (51-1 to 51-3), a property record DB node calculator 54, a control command node calculator 55, a job scheduler calculator 56, and a metadata base node 57.

The network 500 is a network for connecting components (calculators) configuring the system, and is realized by Ethernet (trademark). Other calculators are all an IA server comprising a CPU and a storage device.

A program or software is indicated as one component according to the present example in the following description, but it is assumed that the program or software specifically indicates a CPU operating according to the program. Thus, when an expression of “◯◯ program performs ˜” is used, it means that the CPU provided in the calculator performs a processing for the operation according to the program.

The data node calculators 51 function to hold data in the distributed storage system, respectively. Hereinafter, a structure of the data node calculators 51 will be described by way of the data node calculator 51-1. The data node calculator 51-1 includes a distributed storage server realizing program 511, an access log acquiring means 512, an access log recording unit 513, a data recording unit 514, a data structure controlling means 515, a data moving means 516, and a data node calculator power supply controlling means 517. Other data node calculators 51 (51-2 and 51-3 in this example) are assumed to basically have the same structure as the data node calculator 51-1, but may have different structures.

The distributed storage server realizing program 511 is directed for realizing a distributed storage node in the data node calculator, and is directed for processing a data access request from a client.

The access log acquiring means 512 is directed for generating and recording access logs as a history of accesses to the distributed storage node (more specifically, the data recording unit 514 provided in the data node calculator). The access log recording unit 513 is a recording medium for storing the access logs generated by the access log acquiring means 512 therein. The access log acquiring means 512 and the access log recording unit 513 correspond to one example of the property estimation source data acquiring/holding means 11.

The data recording unit 514 is a recording medium and software for actually storing therein the data held and stored in the distributed storage.

The data structure controlling means 515 is software for controlling a storage form of the data stored in the data recording unit 514 in response to an instruction from the control command issuing means 551 in the control command node calculator 55. The data structure controlling means 515 corresponds to one example of the data structure strategy control executing means 44.

The data moving means 516 is software for moving the data stored in the data node calculators 51 to other node. The data moving means 516 includes a communicating means for exchanging data with other data node calculators 51. The data moving means 516 corresponds to one example of part of the data arrangement strategy control executing means 43 (on the moving source side in this example). In the present example, it is assumed that the information held and managed by an access destination determining means 571 in the metadata base node 57 needs to be changed when the data is moved.

The data node calculator power supply controlling means 517 is a program for making a node in the stop state (or activating other node) by use of an OS command of the data node calculator 51. The data node calculator power supply controlling means 517 corresponds to one example of the system component control executing means 41.

The property record DB node calculator 54 functions as the property recording unit 2 and the property estimation processing means 12. The property record DB node calculator 54 includes an estimation processing means 541, a DB access processing means 542, and a property record management DB 543.

The property estimation processing means 541 is a program operating on the property record DB node calculator 54, and estimates each property model for data and jobs on the distributed storage system to be controlled. The property estimation processing means 541 corresponds to one example of the property estimation processing means 12.

The property record management DB 543 is a recording medium and database-based software for associating and storing identifiers and property model information for the data and jobs on the distributed storage system. The DB access processing means 542 is an access program for the database. In the present example, the property record management DB 543 and the DB access processing means 542 achieve the property recording unit 2.

The control command node calculator 55 realizes the control strategy determining/command issuing means 31. More specifically, the control command issuing means 551 performs the processing. Though not illustrated, the control command issuing means 551 is assumed to be configured as in FIG. 6.

A job scheduler calculator 56 allocates the jobs to be processed on the distributed storage system to be controlled to the calculators. A task allocating means 561 actually performs the processing. The job scheduler calculator 56 includes a task arrangement strategy controlling means 562 in addition to the task allocating means 561. The task arrangement strategy controlling means 562 is instructed by the control command issuing means 551 in the control command node calculator 55 to control a job arrangement (task arrangement) on the task allocating means 561. The task arrangement strategy controlling means 562 corresponds to one example of the task arrangement strategy control executing means 33.

The metadata base node 57 is a calculator for determining an access destination of the distributed storage, and the access destination determining means 571 is software functioning therefor. As a specific example, the access destination determining means 571 performs a processing of calculating an actually-stored data node from a global file path or calculating a node to be accessed from a global block address.

With the structure, for example, it is assumed that the control processing contents of “to stop a node having a certain or less amount of accesses and to move data to be accessed to another node before stopping the node” are stored for an exemplary simple rule of “when a node having a certain or less amount of accesses in the latest ◯ hours is present.”

In the control strategy determining/executing processing according to the present example, the information acquiring means 313 in the control command issuing means 551 in the control command node calculator 55 first acquires, from the access destination determining means 571 in the metadata base node 57 corresponding to other information managing unit 21, information on which data is stored per node. When a data list per node is acquired, information on the amount of future accesses per data is calculated from the property model per data. At this time, the property model is assumed to be previously estimated based on the access logs for each data and each job.

The control command issuing means 551 in the control command node calculator 55 (more specifically, the information acquiring means 313) searches the property record management DB 543 and acquires a property model per data via the DB access processing means 542 in the property record DB node calculator 54. The control command issuing means 551 (more specifically, the condition determining means 314) uses the acquired property model to calculate the amount of future accesses (the amount of accesses in the latest ◯ hours) of each data.

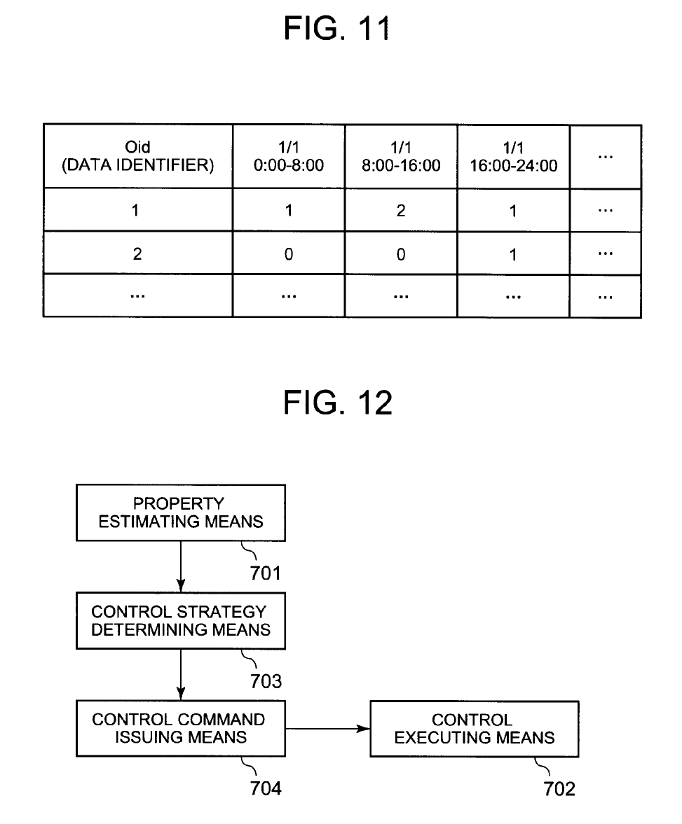

The amount of future accesses may be previously calculated. In this case, the information on the amount of future accesses per data is not calculated by acquiring the property model, and may be searched and acquired from a table calculated and held when the property model is estimated as illustrated in FIG. 11, for example.

FIG. 11 is an explanatory diagram illustrating another exemplary property information stored in the property record management DB 543. FIG. 11 illustrates an example in which information on the amount of accesses at a certain point of time in the future is stored per data.

The amount of accesses in the latest ◯ hours may be calculated per node and a determination may be made as to whether the result has a designated certain value or less on the basis of the amount of future accesses of each data derived from the estimation model. Consequently, if a node having a certain value or less is present, it is determined that the condition is met. A control processing content having a highest priority among the finally-matched conditions may be determined as a control strategy to be executed.

For example, if the control processing contents of “to stop a node having a certain or less amount of accesses and to move data to be accessed to another node before stopping the node” have a highest priority relative to the rule of “when a node having a certain or less amount of accesses in the latest ◯ hours is present” among the matched conditions, the control command issuing means 551 (more specifically, the condition determining means 314) determines the control processing contents as a control strategy to be executed, and issues necessary control commands.

In this example, it is assumed that the data calculator node 51-1 is detected as a “node having a certain or less amount of accesses.” The control command issuing means 551 recalculates an access trend (presence of access, probability of access) until a certain point of time in the future from the property model of the data stored in the data calculator node 51-1, and issues, to the data moving means 516, a control command of, if data to be accessed is present, moving the data to another node (such as other data calculator node 51-2 or 51-3). At this time, the control command issuing means 551 issues a control command of changing the held and managed information to the access destination determining means 571 in the metadata base node 57. Further, the control command issuing means 551 issues, to the task arrangement strategy controlling means 562 in the job scheduler calculator 56, a control command of not allocating a task to the data calculator node 51-1. Finally, the control command issuing means 551 issues a power supply stop command to the data node calculator power supply control 517 in the data calculator node 51-1. With the operations, the amount of consumed power can be reduced while deterioration in performance of the data access is kept reduced.

For example, the data structure may be changed thereby to enhance performance or data capacity efficiency. For example, when the control rules of “when data which is not accessed for a certain period of time in the future is present” and “to compress the data” are present and are the control processing contents with a highest priority, the control command issuing means 551 issues a control command of compressing the data as a command of changing the data structure to the data structure controlling means 515.

In this way, the use form of the system or the situation of the real world is adaptively controlled.

The exemplary embodiment has described the example in which four kinds of control executing means classified depending on a control target are used, but is not limited thereto and may have at least one desired control executing means.

An outline of the present invention will be described below. FIG. 12 is a block diagram illustrating the outline of the control system according to the present invention. As illustrated in FIG. 12, the control system according to the present invention comprises a property estimating means 701, one or more control executing means 702, a control strategy determining means 703 and a control command issuing means 704.

The property estimating means 701 (such as the property estimation processing executing means 12) estimates a property of a task or data on the basis of property estimation source data relating to the task operating on a computer system to be controlled or the data held in the computer system.

The control executing means 702 (such as the system component control executing means 41, the task arrangement strategy control executing means 42, the data arrangement strategy control executing means 43 or the data structure strategy control executing means 44) controls to stop/operate the system components of the computer system, changes a task arrangement, changes a data arrangement, or changes a data structure according to an issued control command.

The control strategy determining means 703 (such as the control strategy determining/command issuing means 31 and the condition determining means 314) determines, as a control strategy to be executed, one or a combination of control processing contents from among controlling to stop/operate the system components in the computer system to be controlled, changing a task arrangement, changing a data arrangement and changing a data structure on the basis of an operation situation of the computer system in the future derived from the property of the task or data estimated by the property estimating means 701.

The control command issuing means 704 (such as the control strategy determining/command issuing means 31 and the command issuing means 311) issues a control command to the control executing means 701 according to the control processing contents determined by the control strategy determining means 706.

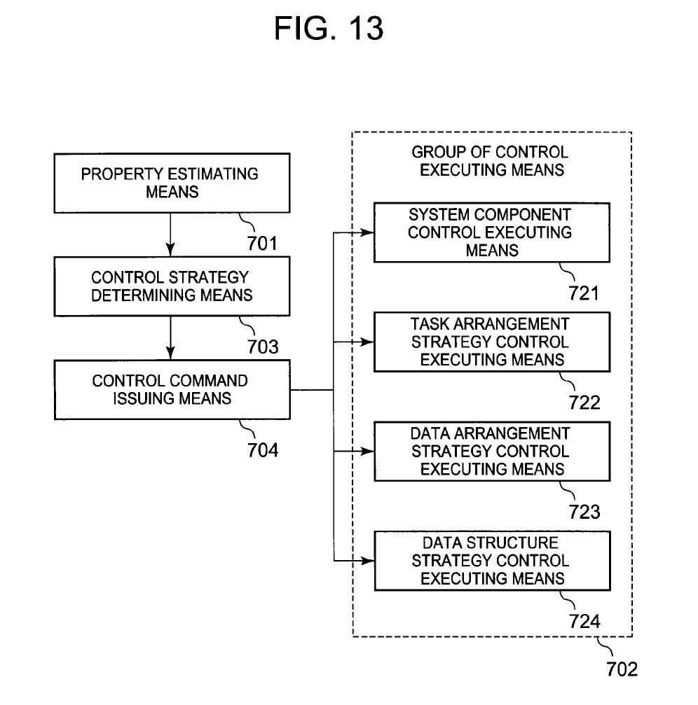

FIG. 13 is a block diagram illustrating other exemplary structure of the control system according to the present invention. As illustrated in FIG. 13, the control system according to the present invention may comprise four control executing means 702 including a system component control executing means 721, a task arrangement control executing means 722, a data arrangement control executing means 723, and a data structure control executing means 724. In this case, the control command issuing means 704 may issue control commands to the task arrangement control executing means 702, the task arrangement control executing means 703, the data arrangement control executing means 704, the data structure control executing means 705 according to the control processing contents determined by the control strategy determining means 706.

The system component control executing means 722 (such as the system component control executing means 41) controls to stop/operate the system components of the computer system to be controlled.

The task arrangement strategy control executing means 723 (such as the task arrangement strategy control executing means 42) changes a task arrangement of the computer system to be controlled.

The data arrangement strategy control executing means 724 (such as the data arrangement strategy control executing means 43) changes a data arrangement of the computer system to be controlled.

The data structure strategy control executing means 725 (such as the data structure strategy control executing means 44) changes a data structure of the computer system to be controlled.

The control system comprises an external environment information acquiring means (such as the information acquiring means 313) for acquiring external environment information indicating situations of the real world from a predetermined information source, and the control strategy determining means may determine a control strategy to be executed by use of an operation situation of the computer system in the future derived from the property of the task or data estimated by the property estimating means and a situation of the real world indicated by the external environment information acquired by the external environment information acquiring means.

The control system comprises a conditions vs control processing contents storage means (such as the processing rules vs control processing contents storing unit 312) for associating control processing contents to be executed as a control strategy with conditions for executing the control processing contents, and the control strategy determining means may determine a control strategy to be executed by determining whether an operation situation of the computer system in the future derived from the property of the task or data estimated by the property estimating means, a situation of the real world indicated by the external environment information acquired by the external environment information acquiring means or a combination thereof meets the conditions stored in the conditions vs control processing contents storage means.

The control system comprises a clustering means for classifying and clustering data or tasks held by the computer system to be controlled according to a similarity with other data or tasks, and the property estimating means may estimate a property of each class classified by the clustering means.

The property estimating means may estimate a property of data or task by calculating a model likelihood based on property estimation source data for one or more property models expressing a trend of use or operation of the data or task, and selecting one or more property models with a model likelihood having a predetermined threshold or more, or a combination thereof.

The computer system to be controlled may comprise one or more controlling means for controlling to stop/operate the system components of the computer system, changing a task arrangement, changing a data arrangement, or changing a data structure according to the issued control commands. In this case, the control command issuing means may issue control commands to the control executing means provided in the computer system to be controlled according to the control processing contents determined by the control strategy determining means.

The present invention has been described above with reference to the exemplary embodiment and the example, but the present invention is not limited to the exemplary embodiment and the example. The structure and details of the present invention may be variously changed within the scope understood by those skilled in the art.

The present application is based on Japanese Patent Application No. 2011-054291 filed on Mar. 11, 2011, the disclosure of which is all incorporated herein.

### INDUSTRIAL APPLICABILITY

The present invention is suitably applicable to a distributed computing system, a distributed storage system, a cloud/computing back end system and the like.

### REFERENCE SIGNS LIST

1 data/task property estimating means
11 property estimation source data acquiring/holding means
12 property estimation processing executing means
121 adaptive model finding means
122 model set recording unit
123 model generating means
124 class adaptive state model finding means
125 data adaptive model finding means
2 property record managing unit
21 other information managing units
3 control strategy determining/command issuing means
31 control strategy determining/command issuing means
311 command issuing means
312 processing rules vs control processing contents storing unit
313 information acquiring means
314 condition determining means
315 processing rules vs control processing contents inputting/outputting means
4 group of control strategy executing means
41 system component control executing means
42 task arrangement strategy control executing means
43 data arrangement strategy control executing means
44 data structure strategy control executing means
701 property estimating means
702 control executing means
703 control strategy determining means
704 control command issuing means
721 system component control executing means
722 task arrangement strategy control executing means
723 data arrangement strategy control executing means
724 data structure strategy control executing means

What is claimed is:

1.-10. (canceled)

11. A control system comprising:
a property estimating unit which estimates a property of a task or data on the basis of property estimation source data relating to the task operating on a computer system to be controlled or the data held in the computer system;
one or more control executing units which control to stop/operate system components of the computer system, changes a task arrangement, changes a data arrangement or changes a data structure according to issued control commands;
a control strategy determining unit which determines, as a control strategy to be executed, one or a combination of control processing contents from among controlling to stop/operate system components of the computer system, changing a task arrangement, changing a data arrangement and changing a data structure on the basis of an operation situation of the computer system in the future derived from the property of the task or data estimated by the property estimating unit; and
a control command issuing unit which issues control commands to the control executing unit according to the control processing contents determined by the control strategy determining unit.

12. The control system according to claim 11, comprising four control executing units including a system component control executing unit which controls to stop/operate system components of a computer system to be controlled, a task arrangement control executing unit which changes a task arrangement of the computer system, a data arrangement control executing unit which changes a data arrangement of the computer system, and a data structure control executing unit which changes a data structure of the computer system.

13. The control system according to claim 11, comprising:
an external environment information acquiring unit which acquires external environment information indicating situations of the real world from a predetermined information source, wherein the control strategy determining unit determines a control strategy to be executed by use of an operation situation of the computer system in the future derived from the property of the task or data estimated by the property estimating unit, and a situation of the real world indicated by the external environment information acquired by the external environment information acquiring unit.

14. The control system according to claim 11, comprising:
a conditions vs control processing contents storage unit which associates control processing contents to be executed as a control strategy with conditions for executing the control processing contents, wherein the control strategy determining unit determines a control strategy to be executed by determining whether an operation situation of the computer system in the future derived from the property of the task or data estimated by the property estimating unit, a situation of the real world indicated by the external environment information acquired by the external environment information acquiring unit, or a combination thereof meets the conditions stored in the conditions vs control processing contents storage unit.

15. The control system according to claim 11, comprising:
a clustering unit which classifies and clustering data or tasks held in a computer system to be controlled according to a similarity with other data or task, wherein the property estimating unit estimates a property of each class classified by the clustering unit.

16. The control system according to claim 11, wherein the property estimating unit estimates a property of data or task by calculating a model likelihood on the basis of property estimation source data for one or more property models expressing a trend of use or operation of the data or task, and selecting one property model with a model likelihood having a predetermined threshold or more, or a combination thereof.

17. The control system according to claim 11, wherein a computer system to be controlled comprises one or more control executing units which control to stop/operate system components of the computer system, changing a task arrangement, changing a data arrangement, or changing a data structure according to issued control commands, and the control command issuing unit issues control commands to the control executing unit provided in the computer system to be controlled according to the control processing contents determined by the control strategy determining unit.

18. A control method comprising the steps of:
estimating a property of a task or data on the basis of property estimation source data relating to the task operating on a computer system to be controlled or the data held in the computer system;
determining, as a control strategy to be executed, one or a combination of control processing contents from among controlling to stop/operate system components of the computer system, changing a task arrangement, changing a data arrangement and changing a data structure on the basis of an operation situation of the computer system at a predetermined or designated time in the future derived from the estimated property of the task or data;
and issuing control commands to one or more control executing units which control to stop/operate system components of the computer system, changing a task arrangement, changing a data arrangement or changing a data structure according to the determined control processing contents.

19. A non-transitory computer readable information recording medium storing a control program that, when executed by a processor, performs a method for:
estimating a property of a task or data on the basis of property estimation source data relating to the task operating on a computer system to be controlled or the data held in the computer system;
determining, as a control strategy to be executed, one or a combination of control processing contents from among controlling to stop/operate system components of the computer system, changing a task arrangement, changing a data arrangement and changing a data structure on the basis of an operation situation of the computer system in the future derived from the estimated property of the task or data; and
issuing control commands to one or more control executing units which control to stop/operate system components of the computer system, changing a task arrangement, changing a data arrangement or changing a data structure according to the determined control processing contents.

20. The control system according to claim 12, comprising:
an external environment information acquiring unit which acquires external environment information indicating situations of the real world from a predetermined information source, wherein the control strategy determining unit determines a control strategy to be executed by use of an operation situation of the computer system in the future derived from the property of the task or data estimated by the property estimating unit, and a situation of the real world indicated by the external environment information acquired by the external environment information acquiring unit.

21. The control system according to claim 12, comprising:
a conditions vs control processing contents storage unit which associates control processing contents to be executed as a control strategy with conditions for executing the control processing contents, wherein the control strategy determining unit determines a control strategy to be executed by determining whether an operation situation of the computer system in the future derived from the property of the task or data estimated by the property estimating unit, a situation of the real world indicated by the external environment information acquired by the external environment information acquiring unit, or a combination thereof meets the conditions stored in the conditions vs control processing contents storage unit.

22. The control system according to claim 13, comprising:
a conditions vs control processing contents storage unit which associates control processing contents to be executed as a control strategy with conditions for executing the control processing contents, wherein the control strategy determining unit determines a control strategy to be executed by determining whether an operation situation of the computer system in the future derived from the property of the task or data estimated by the property estimating unit, a situation of the real world indicated by the external environment information acquired by the external environment information acquiring unit, or a combination thereof meets the conditions stored in the conditions vs control processing contents storage unit.

23. The control system according to claim 12, comprising:
a clustering unit which classifies and clustering data or tasks held in a computer system to be controlled according to a similarity with other data or task, wherein the property estimating unit estimates a property of each class classified by the clustering unit.

24. The control system according to claim 13, comprising:
a clustering unit which classifies and clustering data or tasks held in a computer system to be controlled according to a similarity with other data or task, wherein the property estimating unit estimates a property of each class classified by the clustering unit.

25. The control system according to claim 14, comprising:
a clustering unit which classifies and clustering data or tasks held in a computer system to be controlled according to a similarity with other data or task, wherein the property estimating unit estimates a property of each class classified by the clustering unit.

26. The control system according to claim 12, wherein the property estimating unit estimates a property of data or task by calculating a model likelihood on the basis of property estimation source data for one or more property models expressing a trend of use or operation of the data or task, and selecting one property model with a model likelihood having a predetermined threshold or more, or a combination thereof.

27. The control system according to claim 13, wherein the property estimating unit estimates a property of data or task by calculating a model likelihood on the basis of property estimation source data for one or more property models expressing a trend of use or operation of the data or task, and selecting one property model with a model likelihood having a predetermined threshold or more, or a combination thereof.

28. The control system according to claim 12, wherein a computer system to be controlled comprises one or more control executing units which control to stop/operate system components of the computer system, changing a task arrangement, changing a data arrangement, or changing a data structure according to issued control commands, and the control command issuing unit issues control commands to the control executing unit provided in the computer system to be controlled according to the control processing contents determined by the control strategy determining unit.

29. The control system according to claim 13, wherein a computer system to be controlled comprises one or more control executing units which control to stop/operate system components of the computer system, changing a task arrangement, changing a data arrangement, or changing a data structure according to issued control commands, and the control command issuing unit issues control commands to the control executing unit provided in the computer system to be controlled according to the control processing contents determined by the control strategy determining unit.
